(19) United States
(12) Patent Application Publication
(10) Pub. No.: US 2009/0112568 A1
(43) Pub. Date: Apr. 30, 2009

(54) Method for Generating a Simulation Program Which Can Be Executed On a Host Computer

(75) Inventors: Matthias Doerfel, Hessdorf (DE); Christian Lederer, Erlangen (DE); Ralf Muenzenberger, Erlangen (DE)

Correspondence Address: KANESAKA BERNER AND PARTNERS LLP, 1700 DIAGONAL RD, SUITE 310, ALEXANDRIA, VA, 22314-2848, US

(73) Assignee: Inchron GmbH, Erlangen (DE)

(21) Appl. No.: 12/084,433

(22) PCT Filed: Nov. 3, 2006
(86) PCT No.: PCT/EP2006/010565

§ 371 Date: Aug. 1, 2008

(30) Foreign Application Priority Data
Nov. 4, 2005 (DE) 10 2005 053 053.2

(51) Int. Cl. G06F 9/455

(52) U.S. Cl. 703/22

(57) ABSTRACT

The invention relates to a method for generating a simulation program which can be executed on a computer for the purpose of simulating the function and execution time of a program which is provided to be executed on a target computer, the method comprising the following steps of:
a) providing a source code of the program,
b) producing an optimized intermediate representation of the program's source code,
c) determining execution times on the basis of the optimized intermediate representation of the program's source code,
d) generating an object code, which can be executed on a host computer, on the basis of the optimized intermediate representation of the source code and then
e) combining the execution times, the object code and a prescribed simulation library using a linker, such that a simulation program which can be executed on the host computer is produced.

The invention relates to a method for generating a simulation program which can be executed on a host computer and to a method for simulating the function and execution time of a program which is provided to be executed on a target computer.

According to the prior art simulation programs are known which make it possible to simulate the function of a program which is provided to be executed on a target computer. Such simulation programs do not make it possible to simulate the temporal behaviour, for example the execution time, of the program. In particular, it is not possible to simulate the temporal behaviour of a real-time system.

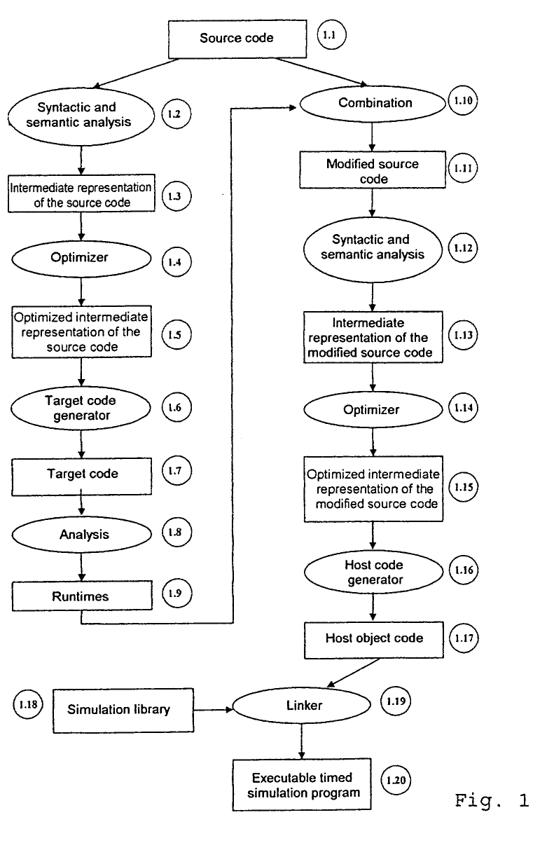

FIG. 1 shows a flowchart of a method for generating an executable timed simulation program according to the prior art. This makes it possible for a execution time of a program which is provided to be executed on a target computer to be taken into account during a simulation on a host computer. A plurality of steps are required for this purpose: starting from a source code 1.1 of a program, the execution times (see step 1.9) result from execution of steps 1.2, 1.4, 1.6 and 1.8. This may be effected, for example, in an automated manner using a computer program. It is also possible to omit steps 1.2 to 1.9 and to manually input the execution times in step 1.9.

After step 1.9, a “modified source code” is produced in step 1.11 by changing the source code 1.1 in step 1.10 “combination”. The modified source code is a version of the source code containing cross-references for the purpose of taking the execution times into account during the simulation.

By way of example, step 1.10 for generating a modified source code 1.11 is carried out manually in the simulation program “RapiTime” from the company Rapita Ltd., York, UK or the simulation and modelling language “SystemC”. In this case, a detailed specification must be given, for each instruction of the source code or for groups of instructions, of how these influence the temporal behaviour and assignment of operating means. In the examples stated, this is effected by means of an additional program code in the form of function calls whose names and semantics are defined by the simulation program used.

Examples of the automated performance of step 1.10 are the simulation programs “Metrix” and “Meteor” from the company Vast System Technology Cooperation, Sunnyvale, USA, which are also described in U.S. Pat. No. 6,230,114 B1. In this case, the execution times are determined in an equivalent manner to steps 1.2, 1.4, 1.6 and 1.8. After the source code has been syntactically and semantically analysed, an intermediate representation of the source code is generated in accordance with step 1.3. In accordance with step 1.4, an optimizer or a prescribed optimization program generates therefrom an optimized intermediate representation of the source code 1.5. This is translated into a target code (see step 1.7) by the target code generator in accordance with step 1.6. According to the prior art, this is target object code or a target assembler code. The execution times (see step 1.9) of the basic blocks are then determined in step 1.8 “analysis”. Due to the insertion of cross-references in step 1.10 which refer to the execution times of the basic blocks determined in step 1.8, a modified source code is produced from the original source code in step 1.11.

In further steps 1.12, 1.14 and 1.16, the modified source code is translated into a series of machine commands which can be executed on the host computer, the so-called host object code (see step 1.17). Steps 1.12, 1.14 and 1.16 are executed by a compiler. In step 1.12, the compiler performs a syntactical and semantical analysis of the modified source code and generates an intermediate representation of the modified source code (see step 1.13). In a subsequent step, an optimizer (see step 1.14) is utilized to generate an optimized intermediate representation of the source code (see step 1.15).

After the generation of the optimized intermediate representation of the modified source code with the optimizer, a host code generator is used to generate the host object code (see step 1.17) in step 1.16. A linker is used in step 1.19 to transfer the host object code into the executable timed simulation model (see step 1.20) using a simulation library (see step 1.18) containing the object code of the simulator.

The optimizations performed with the optimizer according to the prior art using the modified source code lead to results which are different to those in the case of an unaltered source code. As a result, functions, parts of functions, basic blocks and individual instructions can be executed, during the simulation, in an order which is different to that on the target computer. Series of commands and the number of commands in a basic block for the analysis of a basic block may differ from the real system during the simulation. It is also possible to execute functions, parts of functions, basic blocks and individual instructions which are not executed at all on the target computer. The simulation may thus lead to results which are considerably different to those when executing the program on the target computer.

Apart from this, use and assignment of the registers in the microprocessor is less efficient. More memory access operations take place during the simulation on a host computer than during the execution of the program on the target computer.

The differences in the use and in the results of the optimizations of the compiler for the host computer and of the compiler for the target computer result in the simulation on the host computer differing from the real execution of the program on the target computer. If the objective of the simulation is to determine and analyse the temporal behaviour of the program on the target computer or its assignment of operating means, the results may be distorted, and even rendered unusable, by the different optimization results.

In the above-described method according to the prior art, the source code is considerably modified. Such a considerable modification to the source code may be avoided, according to the prior art, only when, instead of translating the source code into the machine language of the host computer, it is translated into the machine language of the target computer and is then executed once it has been interpreted and simulated. When using a simulation program to interpret each command, the aspects which are relevant to the user, for example an exact execution time and functional execution, are determined and displayed. Simulation programs which operate in accordance with this principle are also referred to as instruction set simulators. They are specialized for one respective type of microprocessor and simulate a program not at the level of the source code but at the level of the machine command and can consequently be used only to a restricted extent. A multiplicity of steps on the host computer are required for each simulated machine command of the target computer. Consequently, this method is very intensive in terms of computation time and slow. In particular, it is not suitable for simulating complex real-time systems or multiprocessor systems.

It is an object of the invention to avoid the disadvantages according to the prior art. In particular, the intention is to specify a method with which distorting simulation runs are avoided. Another objective of this invention is to reduce the simulation time.

This object is achieved by means of the features of Claims 1, 20 and 21. Appropriate embodiments result from Claims 2 to 19.

According to the invention a method for generating a simulation program is provided which can be executed on a computer for the purpose of simulating the function and execution time of a program which is provided to be executed on a target computer, the method comprising the following steps of:
a) providing a source code of the program,
b) producing an optimized intermediate representation of the program's source code,
c) determining execution times on the basis of the optimized intermediate representation of the program's source code,
d) generating an object code, which can be executed on a host computer, on the basis of the optimized intermediate representation of the source code and then
e) combining the execution times, the object code and a prescribed simulation library using a linker, such that a simulation program which can be executed on the host computer is produced.

In the method according to the invention, an optimized intermediate representation of the program's source code is generated for the target computer. To this end, the source code runs through the same or comparable optimization methods as in the compiler which generates the machine code (target code) for the target computer.

A modified source code according to the prior art is not required. The execution times for generating the executable timed simulation program are taken into consideration only after the optimized intermediate representation of the source code has been generated. A further optimization is not effected after this consideration, thus avoiding distorting simulation runs. The simulation time can also be considerably reduced. Consequently, the method according to the invention is particularly suitable for generating a simulation program for real-time systems or multiprocessor systems.

A real-time system is generally understood as meaning a system which must be guaranteed to provide a result within an interval of time that has been firmly defined in advance or at a particular point in time. Such real-time systems are widespread. Real-time systems are present, for example, in mobile telephones, antilocking systems, engine or washing machine controllers.

In order to examine a program, in particular a program of a real-time system, in a simulation, the simulation program requires information regarding the temporal behaviour of the program when it is executed on the target computer. The information is used to prescribe the execution times of program parts. The program parts may be functions, parts of functions, basic blocks, sequences of instructions or individual instructions.

In programming, a function or method is understood as meaning a connected section of the source code which makes it possible to implement a particular task in a reusable manner. Functions are incorporated into the execution of programs using function calls. An instruction is a command or a series of commands in a programming language. A basic block denotes a sequence of instructions, the first instruction of which represents the only entry point into the sequence. The other instructions of the basic block are executed precisely when, and only when, the entry point was executed. There is no exit point apart from the end of the sequence. The exit point may also be a conditional or unconditional program branch.

A linker, which is also referred to as a linkage loader, is understood as meaning a program which compiles and links individual program modules to form an executable program.

In a simulation, experiments can be performed on a simulation model. Knowledge of the function and execution time of a program which is provided to be executed on a real system can be obtained therefrom.

The real system may be one or more target computers having one or more processors. If a plurality of target computers are used to carry out a task, it is a so-called multiprocessor system or distributed system.

The real system (also referred to as the target system), which is also denoted by the term “target computer” in the sense of this application for the purpose of simplification, may also comprise the hardware, operating means, peripherals, environment, their interactions and the like. The environment denotes the conditions, influences and interactions which prevail at the time the program is being executed and may have an effect on the program flow.

The simulation is preferably performed on a host computer which is different to the target computer. Of course, it is also possible that the host computer and the target computer are identical. The simulation may also be performed on a host system. The host system may comprise a plurality of host computers. The host system may also comprise hardware, operating means, peripherals, environment, their interactions and the like. Unless explicitly mentioned otherwise, the term “host computer” is also understood as meaning the “host system” in the sense of this application. The simulation program may be executed on the host system in the form of a distributed program.

A simulation program is understood as meaning a computer program whose subject matter, content and representation is constructed for the purpose of simulation. A program (also referred to as computer program) is understood as meaning a defined workflow on a computer which can be used to achieve a particular objective. The workflow comprises a series of individual commands which are processed by a computer. A program is usually written in a programming language which can be read by a person, for example C, C++, Java or Ada, as text, which is also referred to as source code, source text or program code. Before the program can be executed by a computer, it must be converted into machine language and finally into a series of bits. This may be effected either by means of a compiler or, at the execution time, by means of an interpreter, if necessary, also by byte code, as in the case of the Java programming language, for example.

A compiler, also referred to as translator is a computer program which converts the source code of a program which has been written in a source programming language into a semantically equivalent program in a target programming language. This usually involves the translation of a source code which has been written in a programming language by a programmer into an assembler language, a byte code or a machine language. The source code which has been translated into the machine language is referred to as object code. The use of a compiler is referred to as compiling.

The simulation of the program of the target computer on the host computer is possible, if the program has been written in a programming language for which there is also an implementation for the host computer. This is the case for high-level languages, for example C, C++ or Java. The environment and the operating system of the target computer are reproduced on the host computer by a simulation environment.

An operating system is understood as meaning a program which makes it possible to use the operating means of a computer, for example memory, input and output devices, and controls the execution of programs.

In order to simulate the program for the target computer on the host computer, the source code is transformed into an executable simulation program. An executable simulation program is understood as meaning a simulation program which can be executed on a host computer either directly as a program or using a co-simulation program. A co-simulation program provides a simulation environment. This is a reproduction of the real environment of the simulated real system in order to allow the same conditions, influences and interactions to act on the simulated program flow during the simulated program execution. The co-simulation program can execute the necessary interaction with the user. Interaction of a user or of the environment of the target computer can also be simulated using the executable simulation program.

According to one embodiment of the method, the simulation program can be executed on the host computer using a prescribed co-simulation program. Of course, the simulation program may also be executed directly on the host computer.

The program may comprise program parts which are executed on a plurality of target computers while the program is being executed. It is also possible for the simulation program to be generated for the purpose of simulating the function and execution time of the program parts which are provided to be executed on a plurality of target computers.

According to one advantageous embodiment of the method, the optimized intermediate representation of the source code is produced, from a previously produced intermediate representation of the source code, using a prescribed optimization program. In order to produce the intermediate representation, the source code is preferably syntactically and semantically analysed and changed in such a manner that function elements contained in the source code are converted into corresponding function elements of the host computer. The optimization program is used to restructure workflows in order to improve their efficiency. In this case, an objective is to achieve an optimum execution speed or program size. Processor-independent rules are generally used for optimization, for example unused basic blocks are removed or adaptations to specific properties, for example the number of registers or special machine commands, of a respective microprocessor are used.

According to one particularly advantageous embodiment of the method, a respective identification character is assigned to one, several or all of the execution time(s) generated in step c) in order to uniquely identify it/them. Cross-references corresponding to the identification characters are preferably inserted into the object code in step d) or e). Function calls corresponding to the cross-references may also be inserted into the simulation program in step e). Cross-references between the executable timed simulation program and time information regarding the target computer can be produced in a particularly simple manner. A particularly high simulation speed can be achieved on the host computer.

In one embodiment of the method, the function calls are configured in such a manner that they are used to transfer a machine-readable character, which is uniquely assigned to the respective cross-reference, to a function which is to be executed. The machine-readable character may be a digit, number, bit string or the like. According to another advantageous embodiment, the function calls may also be configured in such a manner that they are used to transfer a execution time, which is uniquely assigned to the respective cross-reference, to a corresponding function which is to be executed. In this case, the linker is used, in step e), to combine the simulation library with the object code that already contains the execution times so that a simulation program which can be executed on the host computer is produced.

In one embodiment of the method, in addition to the execution times of the source code on the target computer, the assignment of operating means and/or the utilization of operating means of the target computer are also determined during the analysis. The current and/or maximum utilization of operating means can thus also be determined when executing the simulation program.

In another particularly preferred embodiment of the method, execution times are stored in a table in a machine-readable form. The execution times may each be determined for part of the program. The table preferably furthermore stores information regarding utilization and/or assignment of operating means when executing that part of the program on the target computer. Cross-references can be managed in a particularly simple manner using the table. The use of a table makes it possible to rapidly access the execution times and information. The execution times and information may be uniquely assigned. Consequently, the simulation accuracy and speed can be improved. The simulation accuracy can be improved further by using the information that is additionally provided in the table.

According to another embodiment of the method, the information regarding utilization and/or assignment of operating means can also be transferred to a corresponding function which is to be executed. This is the case, in particular, when the function calls are configured in such a manner that they are used to transfer a execution time, which is uniquely assigned to the respective cross-reference, to a corresponding function which is to be executed.

According to one embodiment of the method, execution of at least one, preferably all, step(s) for generating the simulation program is controlled using an additional program. This makes it possible to speed up the method further.

One embodiment of the method provides for an environment of at least one target computer to be taken into account in the simulation program. It is also possible for the environment of at least one target computer to be taken into account in the simulation program. In taking into account influences and interactions of operating means, of the environment etc. during the simulation, the functional and temporal behaviour of the target computer can be simulated in an even more accurate manner.

In another embodiment of the invention, the table may contain, in addition to the time information, data regarding the assignment of operating means by each program part. This makes it possible to determine the temporal profile of the assignment of operating means. Furthermore, the execution times can be corrected if it is not possible to immediately access operating means which have been assigned in another manner.

Another embodiment of the method provides for the simulation program to be able to be executed on a plurality of host computers in the form of a distributed program. The plurality of host computers may be a host system. The distributed simulation model may be directly executed on the host computers. It is also possible to use a co-simulation program which is distributed among a plurality of host computers to execute the simulation program which is distributed among a plurality of host computers.

According to the invention it is also provided a computer program for performing the method according to the invention. That is to say the method steps which are needed to produce the simulation program can be carried out in an automated manner using a corresponding computer program.

According to the invention it is also provided a method for simulating the function and execution time of a program which is provided to be executed on a target computer, said method having the following steps of:
a) generating a simulation program according to the invention, and
b) executing the simulation program on one or more host computers.

The simulation method makes it possible to simulate the program in a particularly rapid and accurate manner. As regards additional advantages, reference is made to the advantages of the simulation program generated according to the invention.

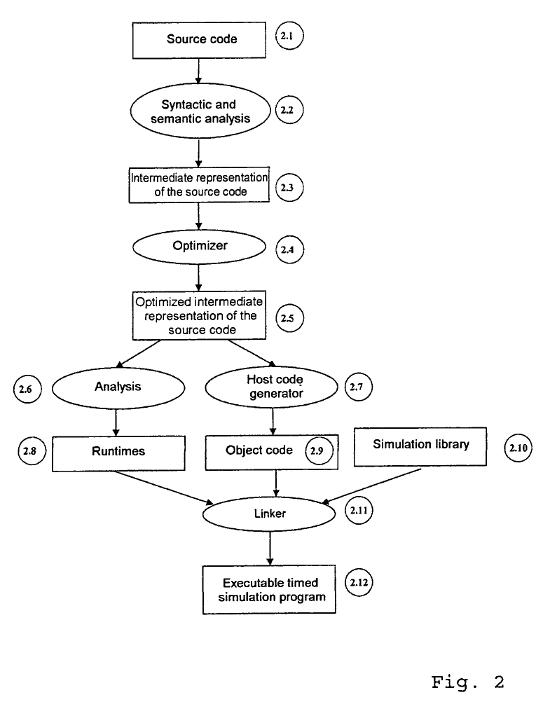

One exemplary embodiment of the invention will be described in more detail below with reference to FIG. 2. FIG. 2 shows a flowchart of a method according to the invention.

In order to generate a simulation program, the following steps are performed:

Following a syntactic and semantic analysis in step 2.2, the source code (see step 2.1) is converted into an intermediate representation of the source code (see step 2.3). In contrast to the method according to the prior art illustrated in FIG. 1, the optimization is performed only on the intermediate representation of the source code 2.3. Optimization of an intermediate representation of the modified source code, as in step 1.13 of the method disclosed in the prior art, does not follow. In step 2.4, the unaltered source code (see step 2.1) runs through the same or comparable optimization methods as in the compiler which generates the machine code for the target computer.

A modified source code is not required. The cross-references to the execution times are produced only when generating an object code (see step 2.9) from the optimized intermediate representation of the source code using a host code generator 2.7. These cross-references are resolved by a linker when generating an executable timed simulation program 2.12 in step 2.11. Distorting simulation runs can thus be avoided.

In order to produce cross-references between the executable timed simulation program and the time information during a simulation, the program part which is currently being executed during the simulation must be known. To this end, the execution times may be stored in a table. The cross-references may be produced by virtue of each program part receiving a unique identification number which denotes the position in the table. The simulation program may, for example, use a function call to transfer the identifier or the identification character of the current program part to the simulator during the simulation.

A function call is preferably inserted for each program part when generating the object code (see step 2.9) using the host code generator in step 2.7 in order to produce cross-references between the simulation program 2.12 and the time information that is stored in the table, for example. The cross-references are produced by virtue of each program part receiving a unique identification number. The function call may transfer the number of this program part as a parameter. The same number is used to identify the execution time 2.8 of the program part which is stored in a machine-readable form. The execution times 2.8 may be input in step 2.6 “analysis” or may be determined in an automated manner using an additional program.

By storing the execution times 2.8 in a table, the number of the program part can be used to clearly deduce the table entry at which the execution time of this program part is stored. This may be effected, for example, by the number of the program part denoting the position in the table.

It is also possible for the table to contain, in addition to the time information, for example the execution times 2.8, data and information regarding the assignment of operating means by each program part. This makes it possible both to determine the temporal profile of the assignment of operating means and to correct the execution times if it is not possible to immediately access operating means which have been assigned in another manner.

The method according to the invention makes it possible to transform a program which is present in source code into a simulation program. The execution of the program on the target computer can be simulated on the host computer in such a manner that the simulation behaves in an equivalent manner to the functional and temporal behaviour of the program on the target computer. The simulation model can be used to simulate the function and temporal behaviour of the program in a particularly accurate and rapid manner. Consequently, the simulation program generated using the method according to the invention can be used to simulate real-time systems.

1. Method for generating a simulation program which can be executed on a computer for the purpose of simulating the function and execution time of a program which is provided to be executed on a target computer, the method comprising the following steps of:
a) providing a source code of the program,
b) producing an optimized intermediate representation of the program's source code,
c) determining execution times on the basis of the optimized intermediate representation of the program's source code,
d) generating an object code, which can be executed on a host computer, on the basis of the optimized intermediate representation of the source code and then
e) combining the execution times, the object code and a prescribed simulation library using a linker, such that a simulation program which can be executed on the host computer is produced.

2. Method according to claim 1, in which the simulation program is executed on the host computer using a prescribed co-simulation program.

3. Method according to claim 1, in which the program comprises program parts which are executed on a plurality of target computers while the program is being executed.

4. Method according to claim 1, in which the simulation program is generated for the purpose of simulating the function and execution time of the program parts which are provided to be executed on a plurality of target computers.

5. Method according to claim 1, in which the optimized intermediate representation of the source code is produced, from a previously produced intermediate representation of the source code, using a prescribed optimization program.

6. Method according to claim 5, in which, in order to produce the intermediate representation, the source code is syntactically and semantically analysed and changed in such a manner that function elements contained in the source code are converted into corresponding function elements of the host computer.

7. Method according to claim 1, in which a respective identification character is assigned to one, several or all of the execution time(s) generated in step c) in order to uniquely identify it/them.

8. Method according to claim 7, in which cross-references corresponding to the identification characters are inserted into the object code in step d) or e).

9. Method according to claim 8, in which function calls corresponding to the cross-references are inserted into the simulation program in step e).

10. Method according to claim 9, in which the function calls are configured in such a manner that they are used to transfer a machine-readable character, in particular a digit or number, which is uniquely assigned to the respective cross-reference, to a corresponding function which is to be executed.

11. Method according to claim 9, in which the function calls are configured in such a manner that they are used to transfer a execution time, which is uniquely assigned to the respective cross-reference, to a corresponding function which is to be executed.

12. Method according to claim 1, in which the execution times are stored in a table in a machine-readable form.

13. Method according to claim 12, in which the execution times are each determined for part of the program and the table furthermore stores information regarding utilization and/or assignment of operating means when executing that part of the program on the target computer.

14. Method according to claim 13, in which the information regarding utilization and/or assignment of operating means is transferred to a corresponding function which is to be executed.

15. Method according to claim 1, in which execution of at least one, preferably all, step(s) for generating the simulation program is controlled using an additional program.

16. Method according to claim 1, in which the behaviour of at least one operating system which is implemented in a target computer is taken into account in the simulation program.

17. Method according to claim 1, in which an environment of at least one target computer is taken into account in the simulation program.

18. Method according to claim 1, in which the simulation program can be executed on a plurality of host computers in the form of a distributed program.

19. Method according to claim 18, in which a co-simulation program which is distributed among a plurality of host computers is used to execute the simulation program which is distributed among a plurality of host computers.

20. Computer program for performing the method according to claim 1.

21. Method for simulating the function and execution time of a program which is provided to be executed on a target computer, said method having the following steps of:
a) generating a simulation program according to claim 1, and
b) executing the simulation program on one or more host computers.
